(19) United States
(12) Patent Application Publication
(10) Pub. No.: US 2009/0106706 A1
(43) Pub. Date: Apr. 23, 2009

(54) uSite - Online software that generates individual websites for personal of commercial business use

(76) Inventor: Donald Catherine, Sacramento, CA (US)

Correspondence Address: Donald Catherine, 11 Milan Court, Sacramento, CA, 95831, US

(21) Appl. No.: 12/027,988

(22) Filed: Feb. 7, 2008

Related U.S. Application Data
(60) Provisional application No. 60/888,679, filed on Feb. 7, 2007.

(51) Int. Cl. G06F 3/048

(52) U.S. Cl. 715/854

(57) ABSTRACT

Embodied within the uSite is the Website Model a method for managing the website Content and Structure. The Website Model is a Simulated Visual Replica of the actual Website which is used to manage both website Content and Structure. The Website Model includes several unique utilities, the Collapsible Framework where features are turned “on or off”, the Web Page Body which is strategically divided into editable regions, and the Powered by bar which provides page-by-page access for instant updating. Any website that embodies the Website Model shall use the utility as a universal tool for simplified Content and Structural Website Management.

### BACKGROUND OF THE INVENTION

Upon the Internet the concept of Web-Based Software which allows for the online management of websites has been uniquely developed over the past few years. The software industry identifies this process as being a type of Website that is Dynamically Generated and or managed from an Online Database. To manage, change and or update the content or structure of a Dynamic Website, or any Database Driven Website, users typically access the Administration (Admin) area thru an On-Line Control Panel. Once inside the Admin area users must navigate thru extremely complicated settings, tables and non user friendly terminology and programming.

### BRIEF SUMMARY OF THE INVENTION

The “Website Model”, is a Visual Simulation of the actual website and a Navigation Guide for non-technical Website Management. The Website Model is a new utility method of managing both the Content and Presentation Structure of any dynamic, and or database driven website. Within the framework of any website, the Website Model can be used to create a visually manageable administration environment for non-technical website owners and managers . . .

### DETAILED DESCRIPTION OF THE INVENTION

The uSite offers the traditional Administration Area or Admin for website management; however the uSite's Admin area includes the Website Model (Claim #1,2,3). The Website Model is a revolutionary utility that is a simulated Model of the actual website. Programmed into the Website Model are navigational point & click links which guide users to update their websites' content or structure.

Beyond the templates and the graphics used by programmers to create and present websites, the Website Model utilities establishes unique features offered specifically for Online Website Management. End user control and management of a website is currently very complicated, and the most demanded feature of a Website. Website owners want to be able to easily add content, make visual changes and edit or update their websites themselves.

The Website Model makes the management of websites both fun and easy. The Website Model instantly generates a visual correlation between the website's look and feel, and the website content and structural management. Because of the model guidance website owners and managers adapted easily to editing and updating their own changes to their website.

The Website Model's utility features are unique; the base feature of the Website Model begins with a simulated visual graphic representation of the actual website's look and feel on the internet. Thus the Website Model is a unique graphical or dynamic model of the Website. The Website Model is much more that the tradition graphic user interface that is used for pure navigation, thru programming useful features includes the following utilities.

Collapsible Framework (Claim #4): For structural changes to the overall look and feel of the website the Website Model includes a programmed utility feature called the Collapsible Framework. Within a Collapsible Framework each Web Site Feature can be turned “ON” or “OFF”. Each time a feature is turned “ON” or “OFF”, the website's online presentation is restructured.

Powered by (Claim #6): The Website Model has functionally changed the meaning, purpose and design of the industry phrase Powered by . . . . Typically within the Internet industry when there is “Powered by” information on a website they are merely links or credits to Service Providers, Advertisers, or Website Designers, etc. Rarely if ever the Powered by information links to administrative functions that allows the user access to modify the individual websites content.

The useful utility and function of the Powered by bar includes links that directly accesses the websites management and content editors. The Website Model's, Powered by bar embodies navigational links to access and update the websites content without the need to enter into the Administration area of the website.

The Powered by bar is located at the very bottom of each web page.

Web Page Body (Claim #5): Every website upon the internet is made up of individual web pages. Whenever two or more pages are linked together on the internet it is a website. Every individual web page has at least one of three active elements Text, Graphics and Forms. Text, Graphics and Forms establishes what is better known as website content. Management of this content is typically done thru the Administration area of the website. However the Website Model embodies a new feature that allows web page content management and editing without having to access the websites Administration area.

Thru the Website Model, managing, editing or updating the website contents can be achieved on a page-by-page basis. Thru programming the layout of the Web Page Body has been strategically divided into Regions or Areas. The Web Page Body is currently divided into 2-Regions, the Page Body-Upper Text and Graphics Area and the Page Body-Lower Form Area. Later a 3^{rd} Area maybe include under the Form Area, entitled the Page Body-Lower Text and Graphics Area.

Dividing the Web Page Body into regions or areas allows for the independent external editing of web page content outside of the typical or traditional Administration area.

Page Editor (Claim #6): The Website Model includes a Pop-up Page Editor for editing and updating the Page Body-Upper Text and Graphics area. The procedure for using this utility is simple. While looking at the web page that the user desires to edit they click on the Page Editor Button, on the Powered by bar. Enter the website user name and password and the Page Editor opens for the editing of the Text and Graphics content for that specific page.

Form Update (Claim 6): The Website Model includes a Pop-up Form Manager for editing and updating the Page Body-Lower Form Area. The procedure for using this utility feature is simple. While looking at the web page that the user desires to edit if a form is included on the page, they click on the Form Update button, on the Powered by bar. Enter the website user name and password and the Form Manager opens for the editing of the Form content for that specific page.

Before a car is built, or a commercial building is built or a plane is built they build a Model. Models act as guides of visual aids to promote understanding. The Website Model utility will dramatically improve the operations and processes associated with the management of website content and website structure. Utilization of the Website Model in any website will be of great benefit to the Internet Industry. Website owners and managers will all benefit from a consistent set of terminology, a uniform presentation model, and an appreciation for ease of use.

Any website which embodies any of the Website Model utilities distinguishes and endorses the Model as a unique utility that enhances or dramatically improves how to navigate the constant updates and changes required for non technical Website Management.

### DESCRIPTION OF DRAWINGS

The uSite Website Model

The uSite Website Model represents the actual Screen Shot of the uSite Administration Control Panel with features or claims that users would click to control the content on there uSite, website.

FIG. 1—The drawing represents a Layout of the Website Model. The Website Model is an actual computer screen shot of the uSite Admin Control Panel (Markings 1 through 17).

Claim #1, 2 and 3
FIG. 1—Is represented by the entire image, users point and click to the desired area of the Model, to Add, Change, Modify, Edit, or Update features (Markings 1 through 17).

Claim #4
FIG. 1—Is represented by the user pointing and clicking on the areas marked 1 thru 14, and 17 to optionally turn a feature on or off.

Claim #5

FIG. 1—Is represented on the drawing by markings number 15 and 16 the divided Text and Graphics area, and the Form area of the web page body.

Claim #6
FIG. 1—Is represented by marking 17, the Powered by Bar

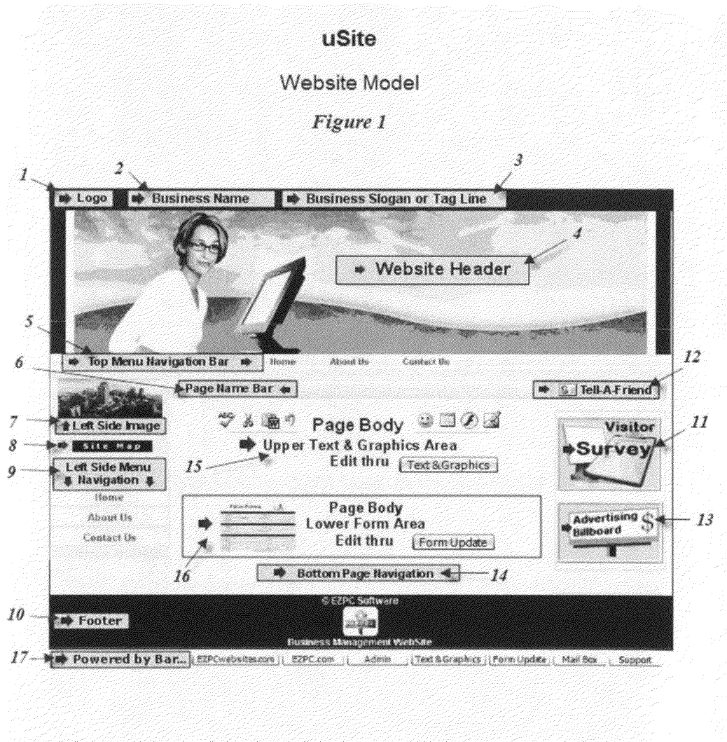

What is claimed is:

1. The “Website Model” utility for a new type of Website Management Process which embodies a unique method for Managing and Editing Website Content and Structure.

2. A website according to claim 1 that includes a Website Model, used to represent a simulated version of the actual websites look and feel.

3. A website according to claim 1 that includes a Websites Model that has a Navigational Framework that when a mouse is used to point and click on a website feature access to manage the websites content is achieved.

4. A website according to claim 1 that includes a Websites Model that has a Collapsible Framework that when a feature is turned “on or off”, the structure of the websites presentation changes.

5. A website according to claim 1 that includes a Web Page Body, which can be divided into multiple but separate regions. The separate Regions can include Website Content for, but be not limited to; one region for text and graphics and the other region for data entry forms.

6. A website according to claim 1 that includes a Powered by bar, which embodies navigational links to access and update the web page body contents without the need to enter into the Administration area of the website.
